(19) United States
(12) Patent Application Publication
(10) Pub. No.: US 2007/0017717 A1
(43) Pub. Date: Jan. 25, 2007

(54) Off-road vehicle with electromotive drive

(76) Inventors: William F. Kuper, Anchorage, AK (US); Donald R. Tunks, Boulder City, NV (US); David Thomas Stiles, Cannon Falls, MN (US)

Correspondence Address: Bruce H. Johnsonbaugh;Eckhoff & Hoppe, Suite 2800, 101 Montgomery Street, San Francisco, CA, 94104, US

(21) Appl. No.: 11/431,316

(22) Filed: May 10, 2006

Related U.S. Application Data
(60) Provisional application No. 60/681,118, filed on May 13, 2005.

(51) Int. Cl. B60L 8/00

(52) U.S. Cl. 180/65.3

(57) ABSTRACT

A drive system is provided for an off-road vehicle that moves across unprepared terrain such as snow, tundra or ice. A plurality of n flexible airbag tires are in contact with the terrain and are driven by n top drive rollers carried by the chassis of the vehicle which frictionally engage and drive the airbag tires. A novel electromotive drive system is provided which includes a plurality of n electromotive drive motors connected to each of the n top drive rollers. Separate controllers having speed sensors and torque sensors are provided for sensing and controlling the instantaneous rotational speed and torque of each independent electromotive drive motor. A central, cab mounted computer based controller responsive to the independent motor controllers and various other inputs controls the instantaneous speed and torque of each of the individual drive motors. The independent speed and torque control of each drive motor is used to increase traction, assist steering, provide braking and regenerative electrical power.

### CROSS-REFERENCE TO RELATED APPLICATION

This application claims the benefit of and priority from U.S. provisional application Ser. No. 60/681,118 filed on May 13, 2005.

### BACKGROUND AND BRIEF SUMMARY OF INVENTION

The present invention relates generally to a drive train for an off-road vehicle. More particularly, the invention relates to an independent wheel electromotive drive train for an off-road vehicle that operates on unprepared terrain with flexible airbag tires in contact with the unprepared terrain. The phrase “unprepared terrain” is used broadly to include snow, tundra, ice, dirt and other natural, unimproved terrain.

The prior art includes off-road vehicles utilizing flexible airbag tires, such as the Vincent et al U.S. Pat. No. 4,007,801, incorporated by reference as though set forth herein in full. The Vincent et al drive train (see FIGS. 1-3) is mechanical with differentials transferring power to individual drive/support rollers mounted to the vehicle frame. The drive/support rollers frictionally engage and drive the airbag tires. A problem with using mechanical differentials in these vehicles is the mismatching of torque delivered by the differential to the individual drive/support rollers. One or two of the drive rollers can require the full torque generated by the engine while other drive rollers are completely unloaded. For example, in crossing bumpy terrain, if an airbag tire loses frictional contact with its drive roller, the drive roller will spin freely, wasting valuable torque. Utilizing mechanical drive will allow for other drive rollers to spin the other airbags since the torque is distributed to the other rollers. The airbag spin will create torque on the unprepared terrain and may cause damage to the vegetive mat. A related drawback of the Vincent et al mechanical differential is in steering the vehicle. For example, in driving the vehicle through a turn, the prior art mechanical differential will split the available torque evenly between the drive rollers. In fact, the vehicle would steer much better if the outer drive rollers could be driven at a greater speed than the inner rollers through a given turn.

The prior art also includes the Albee U.S. Pat. No. 4,325,445, incorporated by reference as though set forth herein in full. As shown in FIGS. 4 and 5, the Albee patent includes an articulation joint 47 between frame sections 43,45. Steering of the flexible airbag tires is accomplished by causing one frame section 43 or 45 to swing relative to the other frame section around the vertical axis 49 of the articulation joint. The Albee '445 patent uses a mechanical differential resulting in the mismatching of torque as noted above. Albee '445 does not teach electromotive drive and does not suggest varying speeds of inner and outer airbag tires to assist in steering the vehicle.

The prior art also includes off-road vehicles that utilize conventional, axle mounted tires, each having an electrical motor that powers the axle (see the Friedrichshafen International Publication No. WO 03/104011). The uniqueness of the present invention of electrically driving each airbag tire over the Friedrichshafen prior art of electrically driving a wheel is in the load and torque transfer. In the prior art wheel driven vehicle, the sidewall of the wheel has to take both load and torque. Higher pressures in the tires are required to transfer these forces and allow sufficient load carrying capability. The prior art wheel-powered unit will lose traction easier than a top roller drive, airbag tire system of the present invention. The uniqueness of independently driving the top roller allows load and torque to be separated from the airbag tire. The adjustable air pressure airbag tire carries the load and the torque is supplied by the top roller to the outer diameter of the airbag tire. The sidewalls of the flexible airbag tire carry the load allowing for lower pressure, increased traction and the ability to change traction. In applying an electrically driven top roller that is rigidly mounted to the frame, the traction is adjustable based on load conditions, air pressure in the flexible airbag tire and terrain. By having both load and full torque control of each airbag tire, a greater controllability, greater traction and efficiency can be achieved in hauling heavy loads across off-road unprepared terrain.

The present invention solves the aforementioned problems and provides increased overall efficiency and greater fuel efficiency as well. According to the present invention, each drive roller is provided with an independent, separately controlled electromotive drive motor. Each of the electric motors and associated controllers will provide the independent power and control of the torque and speed of each of the respective drive rollers which in turn drives its respective airbag tire. The control of the speed and torque of each drive roller will allow for control of the airbag tire and its contact with the ground surface. If, for example, a given airbag tire loses contact with its drive roller, the loss of load borne by the drive roller is sensed immediately, and power is either temporarily reduced or cut off entirely to that roller. This will minimize environmental impact by control of the airbag tire torque. That power is shifted to those drive rollers that are picking up the load, significantly increasing traction of the vehicle. Similarly, in the steering example noted above, the invention will increase the speed of the outside drive rollers to either cause the vehicle to turn or assist the vehicle in turning. The present invention thereby enhances the steering of the vehicle, resulting in more positive steering while requiring less effort by the operator.

Increased traction and steerability are critical for these vehicles which operate off-road in remote arctic and sub-arctic regions in extreme weather conditions. A vehicle stranded in such conditions is difficult to rescue, and the down time and personal danger to the occupants can be great.

Additional benefits are realized by using independent, electromotive drive for each airbag tire. One such benefit is increased braking capacity afforded by electromotive drag when decelerating or when the brakes are applied. Each of the electric motors provides a measure of braking as power to them is reduced when braking. This feature increases the braking performance of the vehicle, especially while carrying heavy loads. A further related benefit is that regenerative braking may be provided, whereby kinetic energy from the vehicle is transferred to each motor through the drive rollers which then may be converted to electrical power and stored as battery energy during braking of the vehicle.

The increased traction, steerability and more efficient use of power reduces fuel consumption and provides a safer vehicle.

A primary object of the invention is to provide an off-road vehicle that moves across unprepared terrain having a drive system that includes top drive rollers that frictionally engage and drive airbag tires wherein each of the airbag tires is independently driven by an electromotive drive motor.

A further object of the invention is to provide an improved drive system for an off-road vehicle utilizing airbag tires and top driven rollers wherein each of a plurality of airbag tires is driven by a separate electromotive drive motor and the rotational speed and torque of each motor is independently sensed and controlled.

A further object of the invention is to provide an off-road vehicle with top drive rollers and airbag tires with improved steering accomplished by increasing the speed of the outside drive rollers and/or reducing the speed of the inside drive rollers to cause the vehicle to turn or to assist the vehicle in turning.

A further object of the invention is to provide an off-road vehicle utilizing airbag tires driven by top drive rollers having increased braking efficiency achieved by rotational drag provided by the inertia of electromotive drive motors.

A further object of the invention is to provide an off-road vehicle having independent electromotive drive motors that respond to the vehicle's braking system and during braking of the vehicle convert rotational kinetic energy of at least two of the drive motors into electrical energy and store the electrical energy in on-board batteries.

Further objects and advantages will become apparent from the following description and the drawings wherein:

### BRIEF DESCRIPTION OF THE DRAWINGS

FIG. 1 is a side elevational view of a prior art off-road vehicle utilizing airbag tires and top drive rollers;

FIG. 2 is a sectional view along the line 2-2 of FIG. 1;

FIG. 3 is a sectional view along the line 3-3 of FIG. 1;

FIG. 4 is a side elevational view of a second prior art off-road vehicle incorporating an articulating frame;

FIG. 5 is a top elevational view of the vehicle shown in FIG. 4;

FIG. 6 is a perspective view of an off-road vehicle according to the present invention having four airbag tires and four top drive rollers;

FIG. 7 is a perspective view of the chassis of the vehicle shown in FIG. 6 and showing the placement of the independent electromotive drive motors;

FIG. 8 is a perspective view looking downwardly at a portion of the chassis of FIG. 7;

FIG. 9 is a bottom view of the vehicle of FIG. 6 showing four airbag tires and four independent electric drive motors;

FIG. 10 is a schematic diagram illustrating the centralized sensor and control system for the vehicle shown in FIGS. 6-9;

FIGS. 11a-11e illustrate the operation of the steering of the vehicle shown in FIGS. 6-9 making a lefthand turn;

FIG. 12 is a conceptual sketch illustrating how the vehicle, such as shown in FIGS. 6-10, transfers torque moving upwardly on an inclined grade;

FIG. 13 illustrates conceptually how the vehicle of FIGS. 6-10 transfers torque to the downhill airbag tires as the vehicle traverses across an inclined grade;

FIG. 14 is a sketch illustrating the vehicle shown in FIGS. 6-9 moving across an inclined grade wherein one of the airbag tires loses contact with its respective drive roller;

FIG. 15 illustrates conceptually how the drive system of the vehicle shown in FIGS. 6-9 combines speed adjustment and torque transfer when the vehicle is moving upwardly and angularly on an incline;

FIG. 16 illustrates conceptually how the vehicle of FIGS. 6-9 utilizes a regenerative battery changing capability during either deceleration or braking;

FIG. 17A is a plan view of an alternate embodiment of the invention having an articulating joint between a front and rear frame section (the cab is shown removed for clarity);

FIG. 17B is a side elevational view of the vehicle 17A showing the cab removed for clarity;

FIG. 17C is a front elevational view of the vehicle 17A and 17B (with the cab removed);

FIGS. 17A-17C illustrate an embodiment having two driven airbag tires and two idler or non-powered airbag tires;

FIGS. 18A-18C illustrate an embodiment of the invention utilizing an articulating frame and having four airbag tires, all of which are driven;

FIG. 18A is a plan view of the embodiment with four airbag tires, each of which is driven;

FIG. 18B is a center sectional view from a line 18B-18B of FIG. 18A;

FIG. 18C is a front elevational view from a line 18C-18C of FIG. 18A;

FIGS. 19A and 19B illustrate a further embodiment of the invention having eight airbag tires, all of which are driven and which utilize an articulating joint between two frame sections;

FIG. 19A is a top plan view of the embodiment with eight airbag tires all driven;

FIG. 19B is a center sectional view on the line 19B-19B of FIG. 19A;

FIGS. 20A and 20B illustrate an embodiment utilizing ten airbag tires, each of which is independently driven and which utilizes an articulating joint between frame sections;

FIG. 20A is a top plan view of this embodiment;

FIG. 20B is a sectional view on the line 20B-20B of FIG. 20A;

FIGS. 21A and 21B illustrate a further embodiment wherein a heavy duty tractor trailer vehicle according to the invention;

FIG. 21A is a plan view of the vehicle;

FIG. 21B is a section on the line 21B-21B of FIG. 21A;

FIG. 22A is a plan view of a portion of the vehicle illustrated in FIGS. 21A and 21B; and

FIG. 22B is a section on the line 22B-22B of FIG. 22A.

### DETAILED DESCRIPTION OF THE DRAWINGS

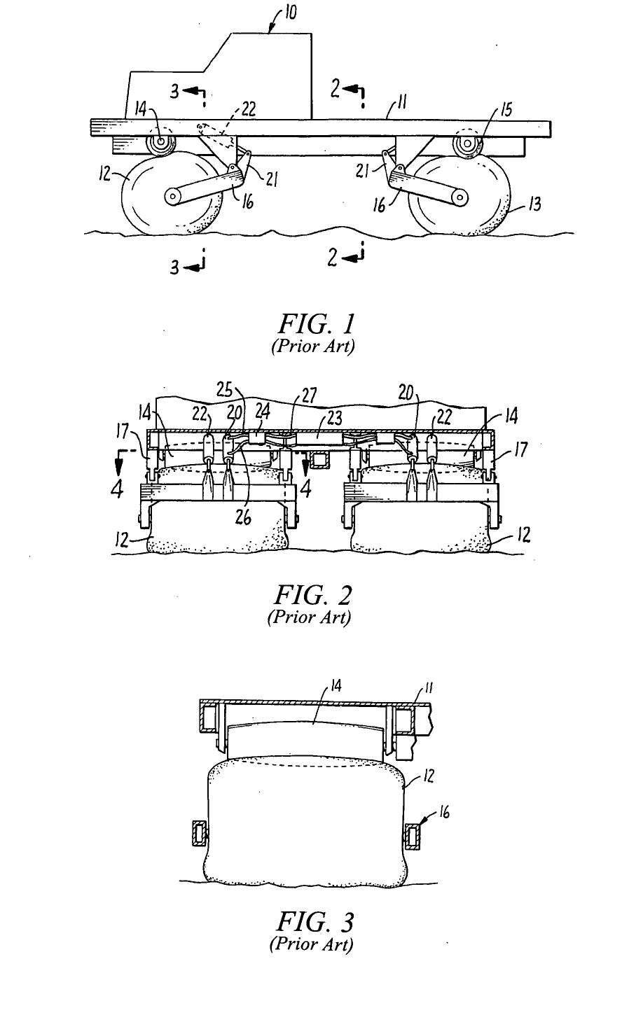

FIGS. 1, 2 and 3 are reproduced from the Vincent et al U.S. Pat. No. 4,007,801 referenced above. The vehicle 10 comprises a frame 11 supported by front flexible wall rollers or airbag tires 12 and rear rollers or airbag tires 13. A pair of front drive/support rollers 14 are provided to frictionally engage airbag tires 12. The rear support rolls 15 are idler rolls and do not provide power to airbag tires 13. However, it is known in the prior art to provide power to airbag tires 15 through mechanical differentials described briefly above. The vehicle 10 shown in FIGS. 1, 2 and 3 has four airbag tires in contact with the unprepared terrain such as snow or tundra upon which it operates. Referring to FIG. 3, it can be seen that if a temporary separation occurs between drive 14 and airbag tire 12, the drive roller 14 would be free to rotate without transmitting any power to airbag tire 12.

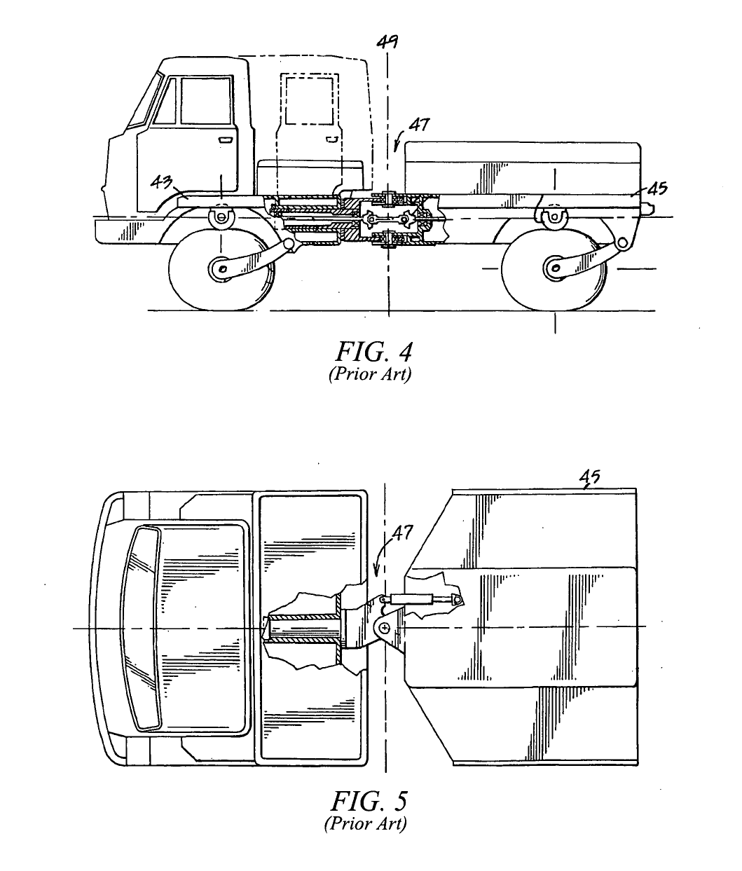

FIGS. 4 and 5 are drawings reproduced from the Albee '445 patent, including a prior art articulating frame joint as noted above.

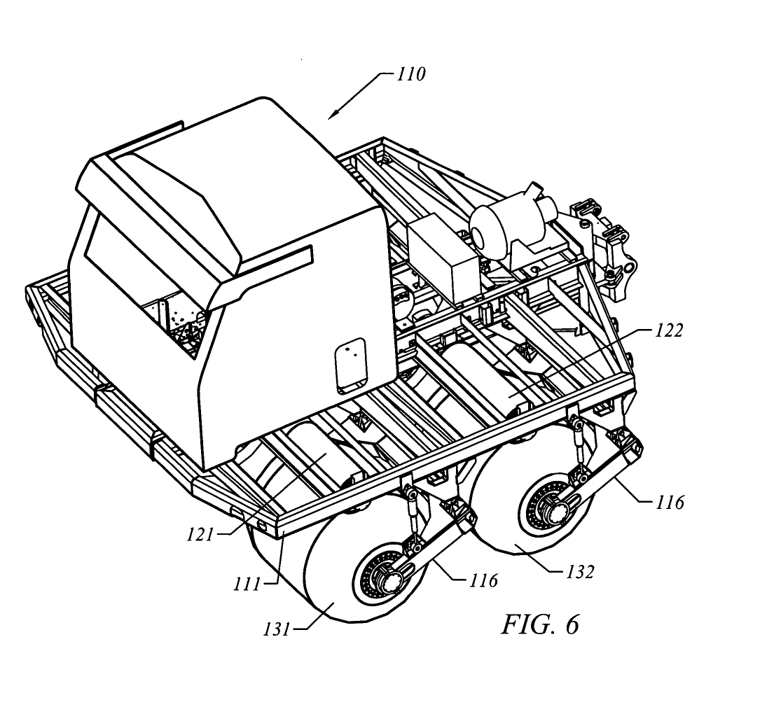

FIG. 6 is a perspective view of an off-road vehicle 110 according to the present invention. Four flexible airbag tires 131-134 (only two of which are visible in FIG. 4) are connected to the non-articulating vehicle frame 111 by yokes 116 similar to those shown in the Vincent et al prior art patent. In accordance with the present invention, four drive rollers 121-124 are provided which are located above and frictionally engage and drive airbag tires 131-134, respectively. Each of the four separate drive rollers is driven by an independent electromotive motor.

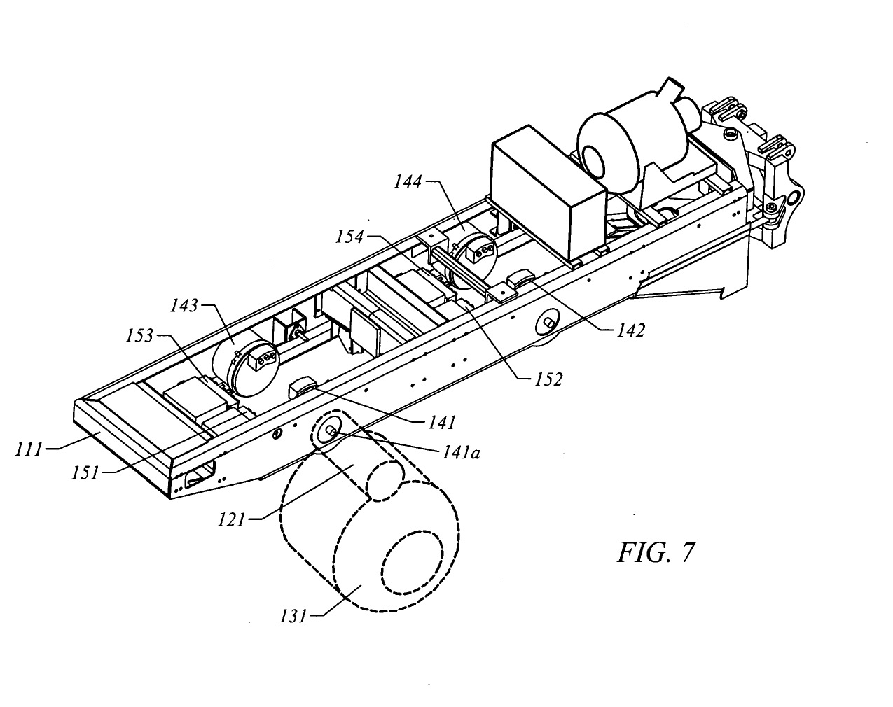

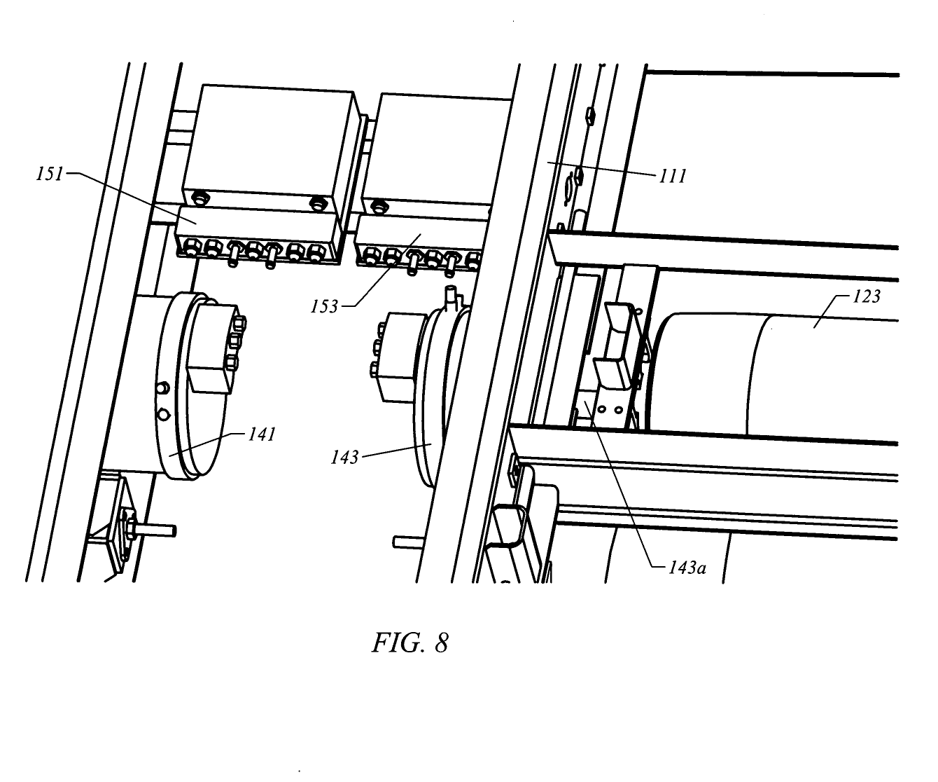

FIG. 7 illustrates the four independent electric motors 141-144 and their location on frame or chassis 111. Independent motor 141 is utilized to power the drive roller 121 with output shaft 141a shown in FIG. 7. Drive roller 121 is in frictional contact with and drives airbag tire 131 (shown in phantom). Each of the motors 141-144 has its own independent speed and torque sensor and controller 151-154 which may be activated by automatic and/or manual controls in the cab of the vehicle.

FIG. 8 is a perspective view looking downwardly at electric motors 141 and 143 used to drive the front airbag tires 131 and 133 (not visible in FIG. 8). Independent motor 143 is shown connected to drive roller 123 through its output shaft 143a. Independent motor controllers 151,153 are shown carried by chassis 111 adjacent motors 141 and 143.

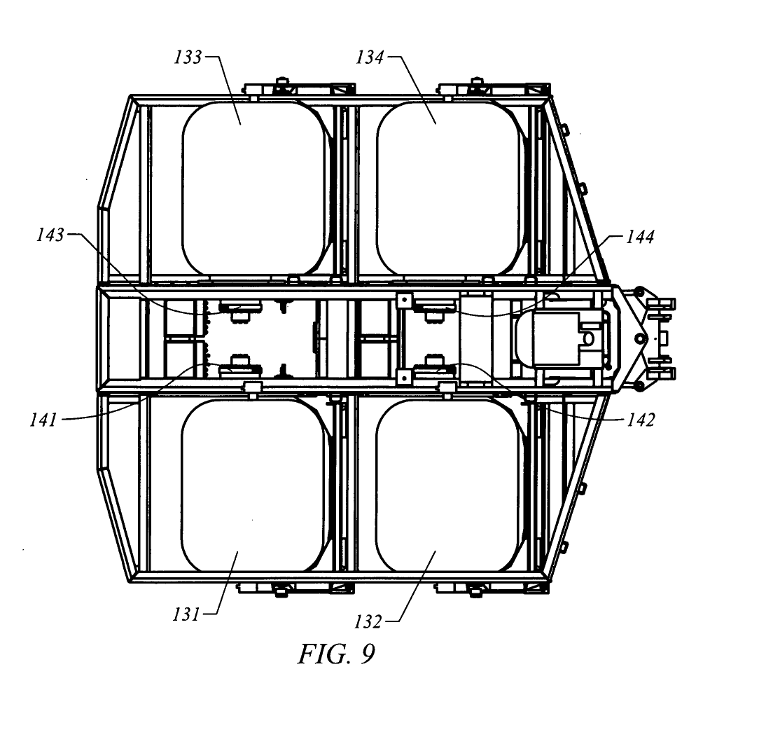

FIG. 9 is a bottom view showing all four airbag tires 131-134, all four independent electric motors 141-144, and independent speed and torque sensors and controllers 151-154.

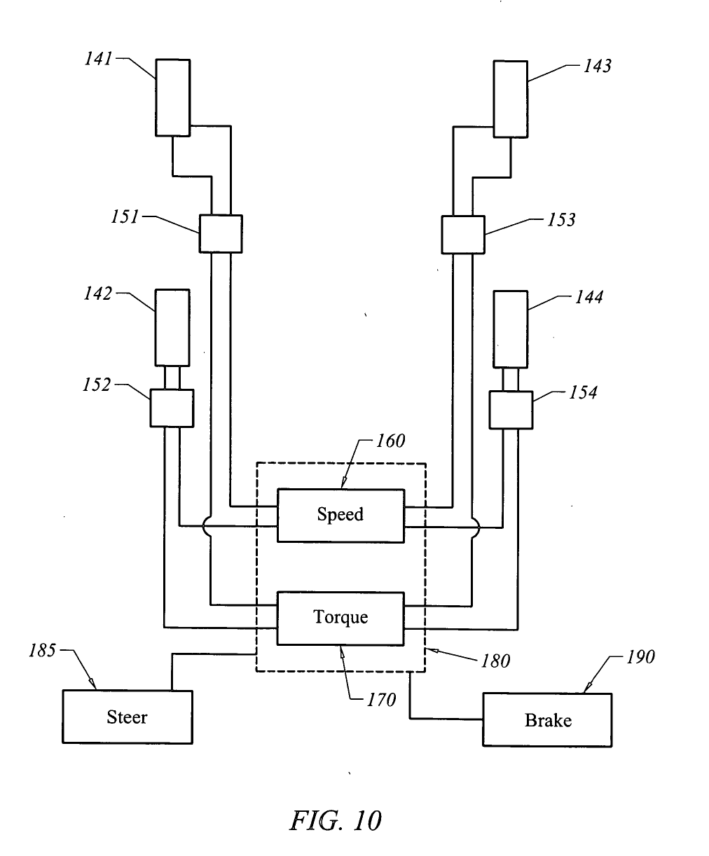

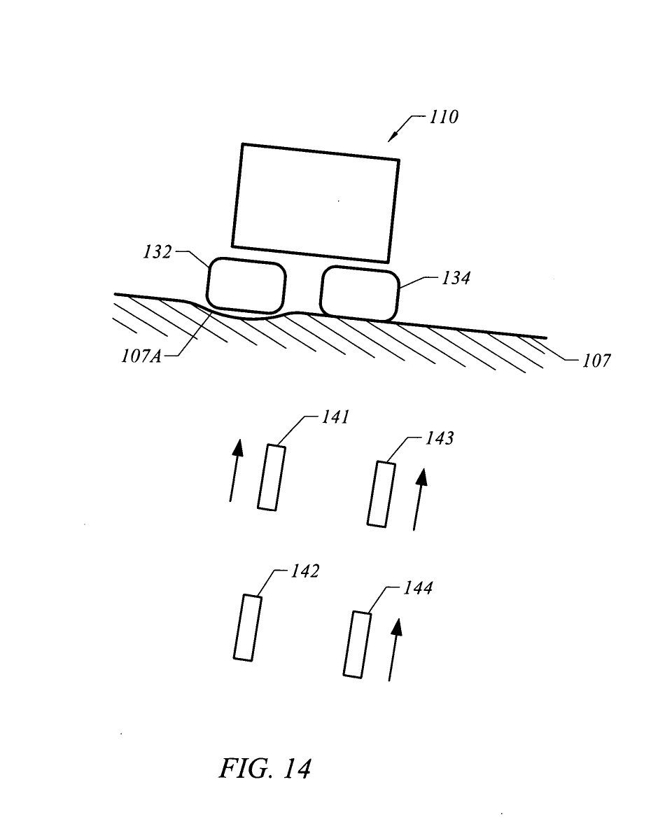

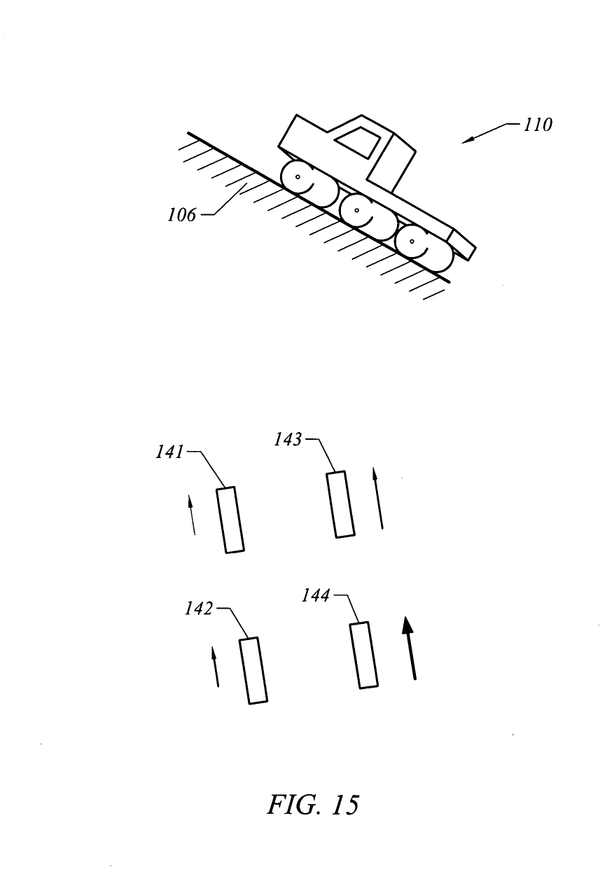

FIG. 10 is a diagram illustrating the centralized control means 180 for independent motors 141-144. As shown in the drawings, motors 141 and 143 are utilized to drive the front left and front right airbag tires of vehicle 110. Motors 142 and 144 are utilized to drive the back left and right back airbag tires, respectively. Each of the four electric drive motors 141-144 is independently controlled by controllers 151-154, respectively. The controllers 151-154 each sense and control instantaneous speed and torque of each motor. The motors 141-144 and controllers 151-154 are connected to a central instantaneous rotational speed and torque sensor and controller (160,170, respectively), positioned within a central control means 180 mounted inside the cab of the vehicle 110. Control means 180 is preferably a programmable digital computer that receives instantaneous speed and torque readings for each motor at central speed and torque sensors 160,170, receives operational instructions from the operator and, in response to those inputs, controls the individual motor speeds and torques to perform the operational instruction, as shown by examples below. The control means 180 is preferably programmed to perform some functions automatically, such as shutting off power to a free-spinning airbag tire, as described below and shown in FIG. 14. By separately and instantaneously sensing and controlling the speed and torque of each of the four motors, significant improvements in traction, steering, overall fuel efficiency and braking are achieved, as noted above and discussed further below.

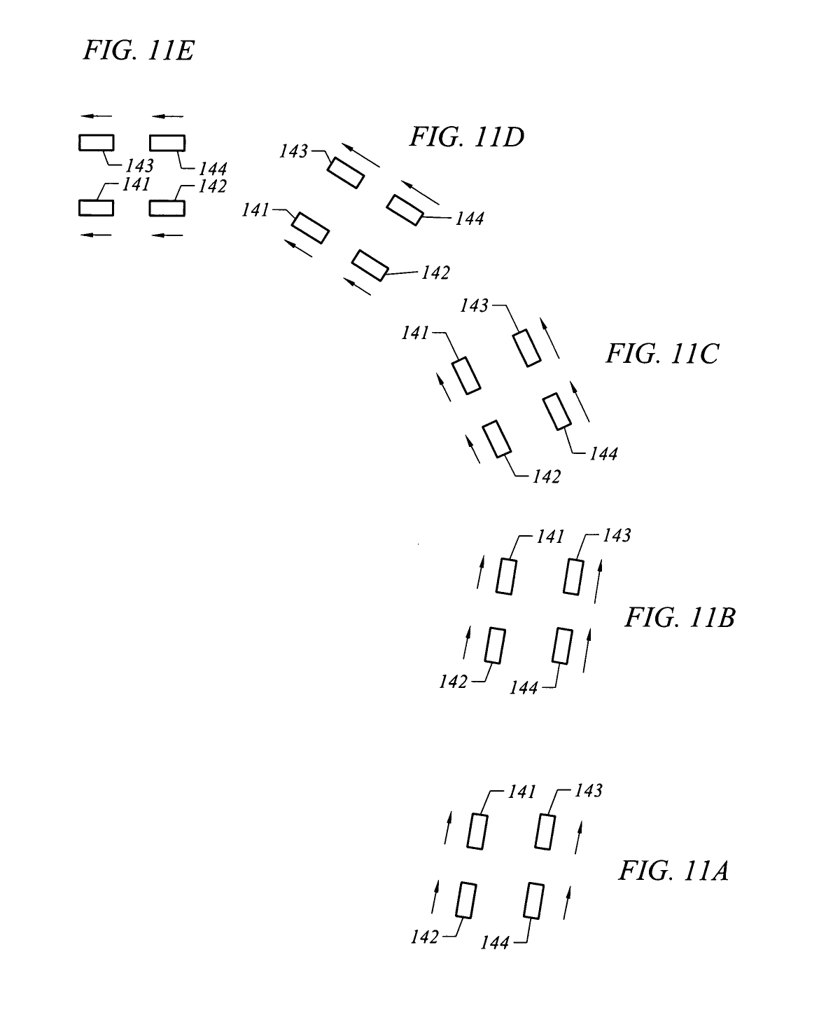

FIGS. 11A-16 are a series of sketches illustrating the improved steering, torque matching, traction and braking characteristics of the present invention.

FIGS. 10 and 11A-11E illustrate conceptually the operation of the improved steering as a lefthand turn is made by the vehicle. FIG. 11A illustrates the four independent drive motors 141-144. The arrows adjacent each drive motor indicate speed by the length of the arrow and torque by the thickness of the arrow. In FIG. 11A each of the four motors has the same speed and torque. As shown in FIG. 11B, to initiate the lefthand turn, the operator actuates a steering wheel 185 (FIG. 10) or other known steering handle (not shown). Control means 180 responds by increasing the speed of the righthand motors 143 and 144 significantly above the speed of the lefthand motors 141 and 142. FIG. 11C illustrates how the greater speed of righthand drive motors 143 and 144 causes or assists the vehicle to turn to the left. FIG. 11D shows a progression of the turn. FIG. 11E illustrates that once the turn has been completed, the speed of the righthand drive motors 143 and 144 is reduced and equalized with the speed of motors 141 and 142 and the vehicle proceeds forwardly in a straight line.

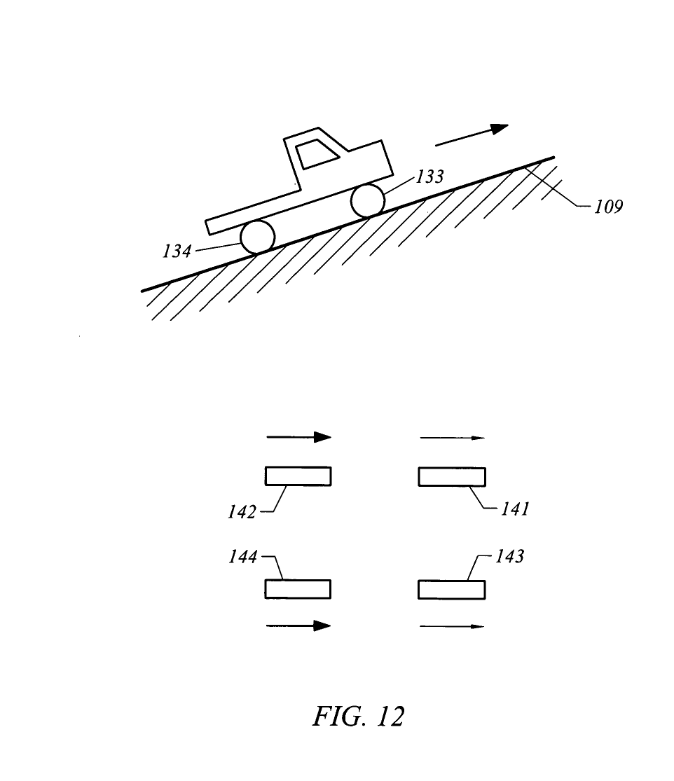

FIG. 12 illustrates how the invention facilitates the transfer torque to match the load demands by each of the drive rollers. As shown in the upper part of FIG. 12, the vehicle 110 is moving from left to right upwardly on an inclined grade 109. The inclined grade 109 causes the rear airbag tires 132 and 134 to bear a significantly greater load than the front airbag tires 131 and 133. In accordance with the present invention, the load borne by rear airbag tires 132 and 134 is sensed by controllers 152,154 and by the central speed and torque sensors 160,170; and the control means in the cab automatically increases the torque supplied to rear drive motors 142 and 144 in proportion to the increased load. This increased torque is indicated by the thickness of the arrows adjacent rear drive motors 142 and 144 as shown in the lower portion of FIG. 12.

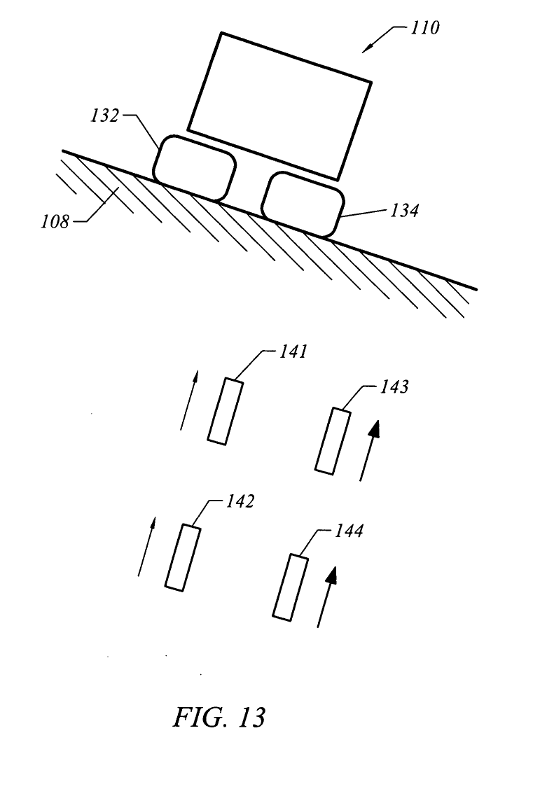

FIG. 13 illustrates another example of torque being transferred and matched to the load borne by each of the four airbag tires and drive rollers. In this example, as shown in the upper portion of FIG. 13, vehicle 110 is traversing across an inclined grade 108 with the lefthand side of the vehicle uphill and the righthand side of the vehicle downhill. The downhill or righthand airbag tires 133, 134 and motors 143 and 144 are bearing most of the load in this configuration. Again, the increased load is sensed and the control means 180 in the cab proportionately increases the torque to the righthand drive motors 143 and 144, as shown by the increased thickness of the arrows adjacent motors 143 and 144 in the lower portion of FIG. 13. The torque applied to each of the four drive motors 141-144 is proportionate to that portion of the load being borne by each of the airbag tires and four motors.

FIG. 14 is an illustration showing, in the upper part of FIG. 14, vehicle 110 moving across a grade 107 having a dip or swale 107a which causes the rear left airbag tire 132 to lose contact with its respective drive roller 122 (not shown in FIG. 14). The drive roller 122 will increase its speed momentarily and will not bear any of the load momentarily. The increased speed and lack of load is sensed immediately by controller 152 (not shown in FIG. 14) and by central speed and torque sensors 160 and 170 and the speed and torque to motor 142 is immediately eliminated or reduced, as shown by the absence of a speed/torque arrow adjacent motor 142. The load is transferred equally to the three remaining drive motors 141, 143 and 144 until frictional contact is regained between drive roller 122 and airbag tire 132.

FIG. 15 illustrates a combination of motor speed adjustment and torque transfer. In this example, vehicle 110 is moving upwardly on an incline 106 but is moving at an angle so that the vehicle 110 is traversing the grade 106 and the driver is steering the vehicle into a lefthand turn to move directly uphill on grade 106. Accordingly, the drive motors 143 and 144 on the righthand side of the vehicle are given increased speed by the driver to initiate the lefthand turn while the speed of the lefthand motors 141 and 142 remains the same as before the turn was initiated. Since the back right airbag tire is bearing the largest load in the example shown in FIG. 15, the torque delivered to motor 144 is significantly increased as shown by the thickness of the arrow adjacent motor 144. Simultaneously, the torque delivered to the extreme uphill motor 141 is reduced as shown by the reduced thickness of arrow adjacent motor 141.

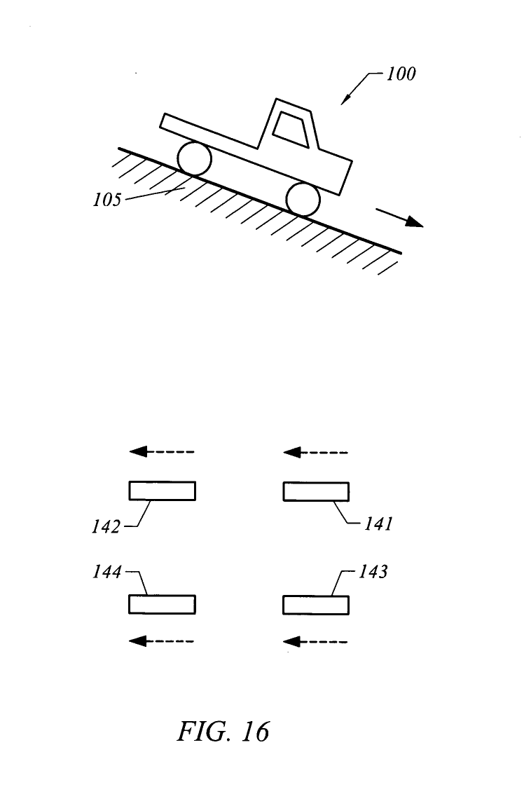

FIG. 16 illustrates the braking regenerative power capability afforded by the present invention during deceleration or braking. In the example shown in the upper part of FIG. 16, the vehicle 110 is descending down inclined grade 105. In this example, the electrical field of the four motors 141-144 is reversed (preferably automatically but optionally by manual control of the operator) which applies a reverse torque to the respective drive rollers and airbag tires. The decelerating and/or descending vehicle 110 must therefore overcome the reverse torque of motors 141-144. As the inertia of the vehicle is resisted by the reverse torque of the motors, as indicated by the dashed arrows next to the motors in FIG. 16, the motors are generating electrical power, as shown by arrows adjacent motors 141-144, which can easily be utilized to charge one or more batteries (not shown) carried by vehicle 110.

FIG. 16 together with FIG. 10 illustrates the general braking means of the present invention. If the operator actuates a brake pedal 190 or other brake actuator (as shown in FIG. 10), the control means 180 senses the brake actuation and reverses the electrical field of at least two of the motors 141-144.

With respect to the embodiment illustrated in FIGS. 6-9, it is within the scope of this invention to utilize only two drive motors as opposed to four drive motors as shown and described above. For example, the front airbag tires 131 and 133 can be driven by electric motors 141,143 and drive rollers 121,123. The rear airbag tires 132 and 134 help support the weight of the vehicle but are not driven. The preferred form of the invention is to provide all wheel drive in the various embodiments shown and described herein. However, it is to be understood that the invention also includes embodiments wherein some of the airbag tires are non-driven and are utilized to help carry and distribute the weight of the vehicle.

The invention applies to the general case of an off-road vehicle having n flexible airbag tires in contact with unprepared terrain and n top drive rollers carried by the vehicle chassis which contact and frictionally engage and drive the n airbag tires; as shown and described herein, n independent electromotive drive motors are connected to the n top drive rollers. As noted above, non-driven airbag tires may also be included as part of the vehicle to help carry and distribute loads.

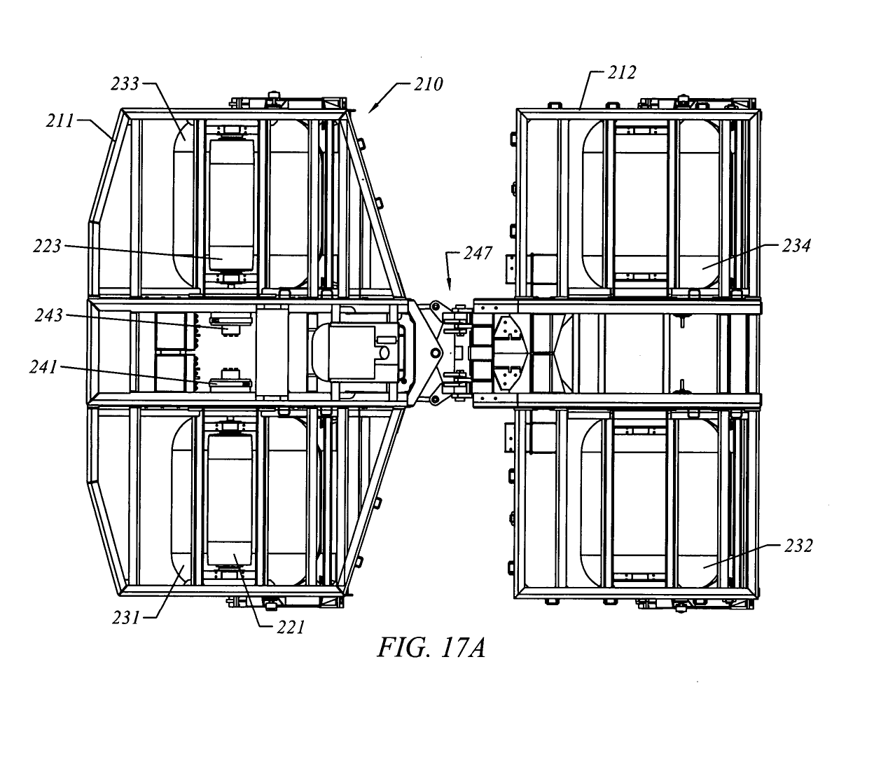

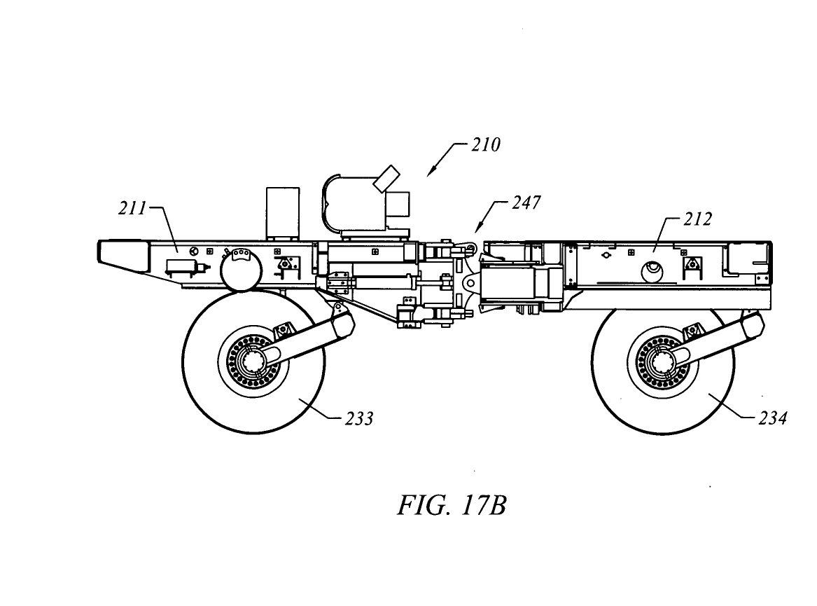

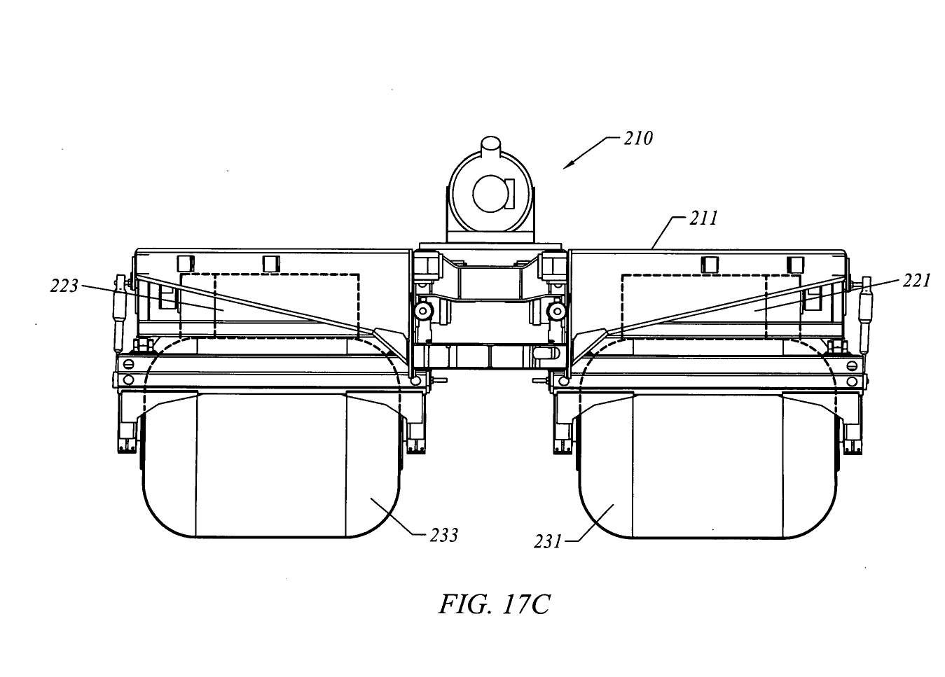

FIGS. 17A-17C illustrate an embodiment of the invention utilizing a front frame section and a rear frame section joined by an articulating joint. The articulating joint may be of the type shown and described in the Albee U.S. Pat. No. 4,325,445 and is not described herein in the interest of brevity. FIGS. 17A is a plan view of the vehicle 210 with the cab removed to illustrate the pertinent components of the drive train of the vehicle. The front frame section 211 is connected to the rear frame section 212 by articulation joint shown generally as 247. Front airbag tires 231 and 233 are driven by drive rollers 221 and 223, respectively. Electric motors 241 and 243 are utilized to provide power independently through drive rollers 221 and 223 to airbag tires 231 and 233, respectively.

The rear frame section 212 is supported by airbag tires 232 and 234, which in this embodiment are not driven and are utilized simply as idler or non-powered airbag tires.

FIG. 17B is a center sectional view of the vehicle 210 shown in FIG. 17A along the line 17B-17B.

FIG. 17C is front elevational view showing frame section 211, airbag tires 231 and 233 and drive rollers 221 and 223.

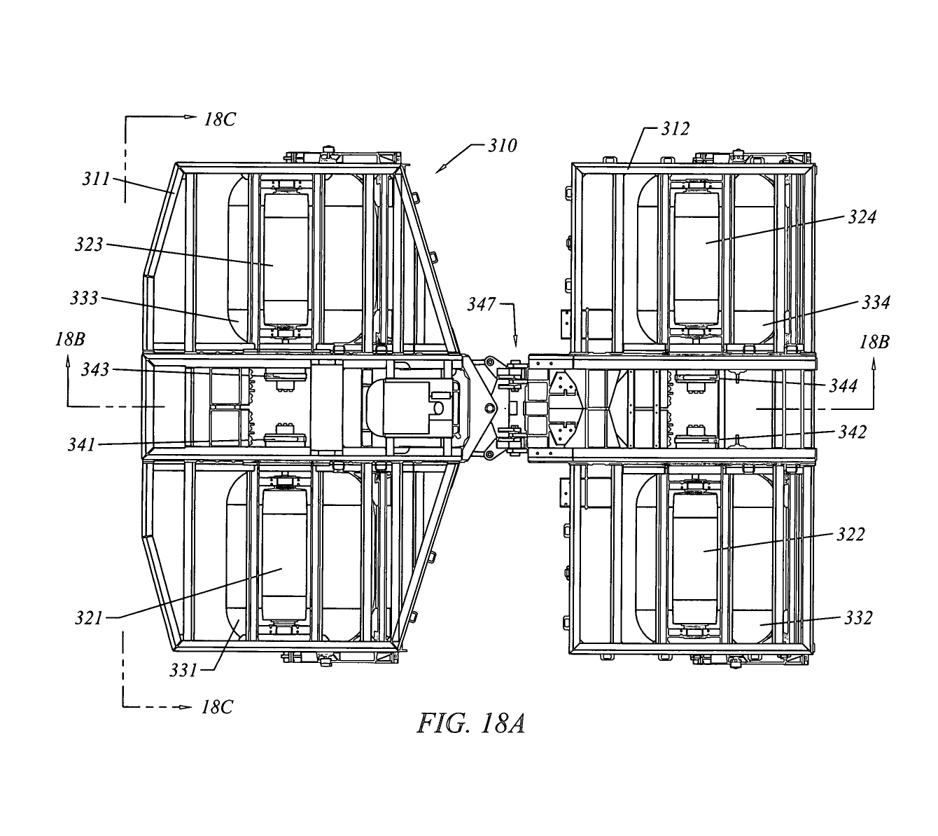

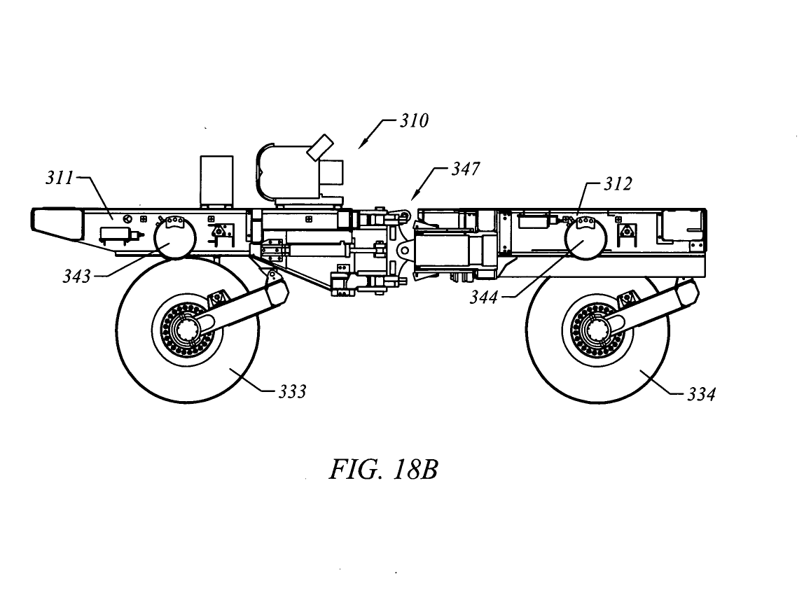

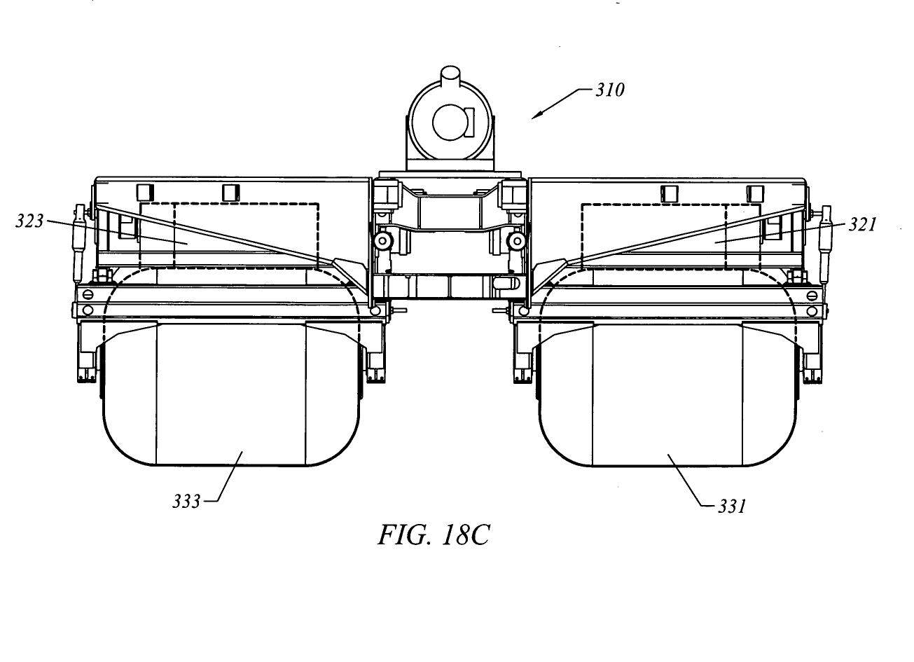

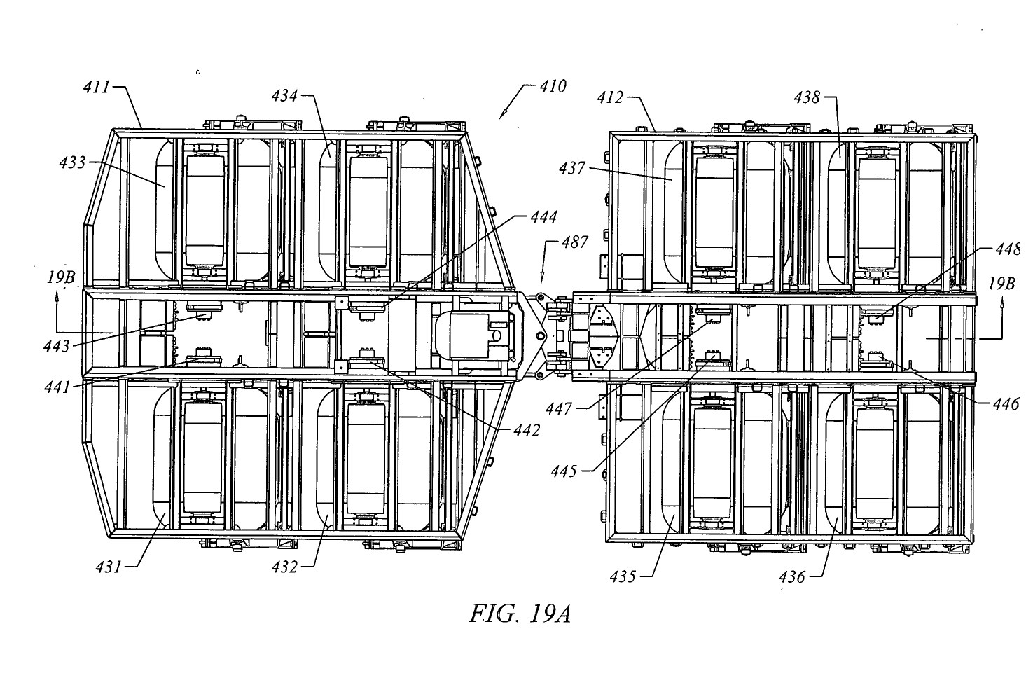

FIGS. 18A-18C illustrate another embodiment of the invention which is essentially a tractor having two articulating frame sections and four airbag tires, all of which are driven. FIG. 18A shows the tractor 310, again with the cab removed to illustrate the components of the frame and drive system. Front frame section 311 is connected to rear frame section 312 by articulating joint 347. The front airbag tires 331 and 333 are powered by motors 341,343 and drive rollers 321,323. Similarly, rear airbag tires 332 and 334 are separately and independently driven by motors 342 and 344 powering drive rollers 322 and 324.

FIG. 18B is a center sectional view on the line 18B-18B of FIG. 18A. Airbag tires 333 and 334 are visible along with their respective independent electric drive motors 343 and 344. The drive rollers 323 and 324 are not visible in the view shown in FIG. 18B.

FIG. 18C is a front elevational view on the line 18C-18C of FIG. 18A. Front airbag tires 331 and 333 are visible along with their respective drive rollers 321 and 323.

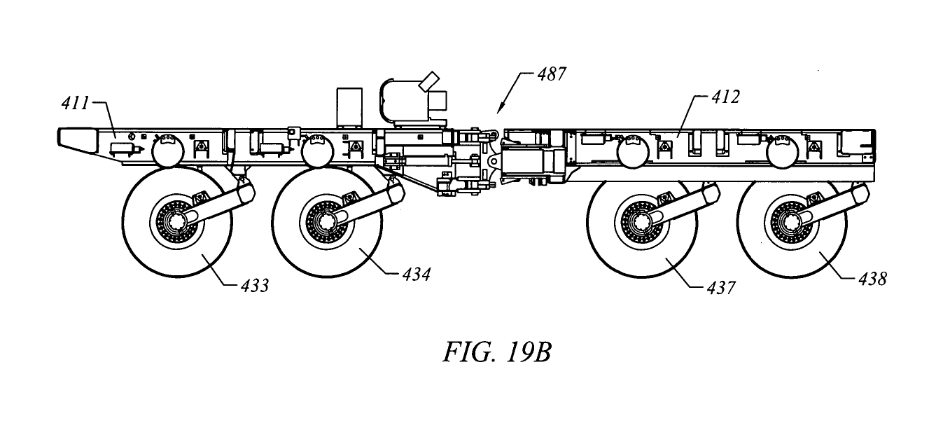

FIGS. 19A and 19B illustrate a further embodiment of the invention which includes a tractor 410 having eight airbag tires, all of which are driven. In this embodiment, a first or front frame section 411 is connected to a second or rear frame section 412 by articulation joint 487. Both the front frame sections 411 and 412 are connected to four independently driven airbag tires 431-434 and 435-438, respectively. Each of the eight airbag tires 431-438 is driven by separate independently controlled electric motors 441-448, respectively.

FIG. 19B is a center sectional view of the apparatus shown in FIG. 19A along the line 19B-19B. Airbag tires 433,434 are shown supporting frame section 411 and airbag tires 437 and 438 are shown supporting frame section 412.

Applicants believe that the embodiment shown in FIGS. 19A-19B is an extremely versatile tractor design which is expected to be utilized frequently in the field.

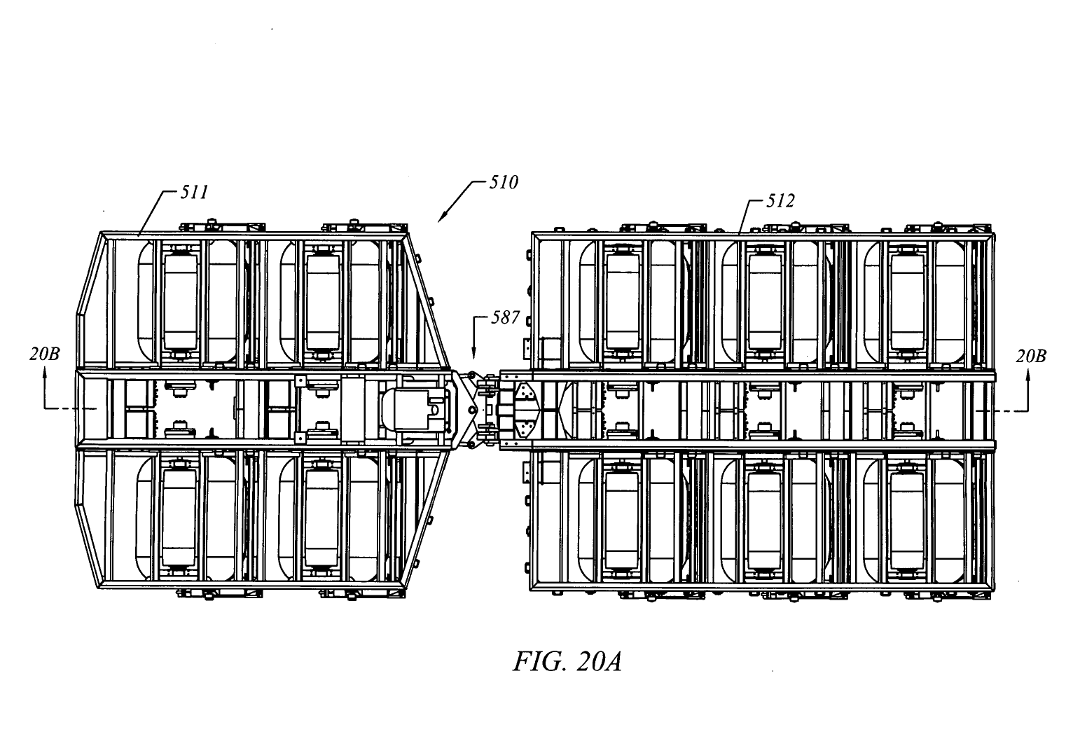

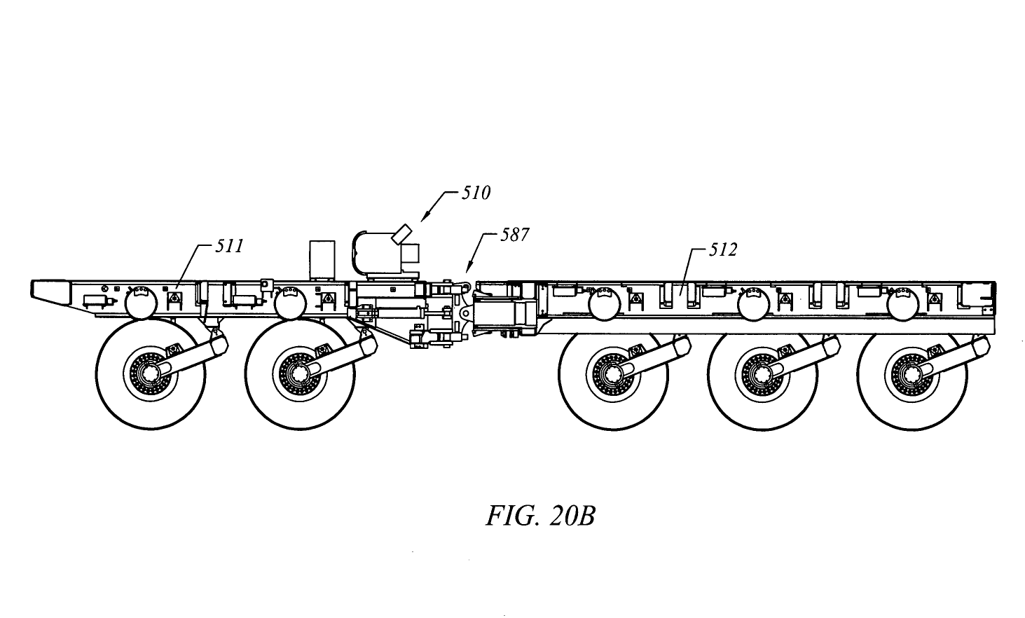

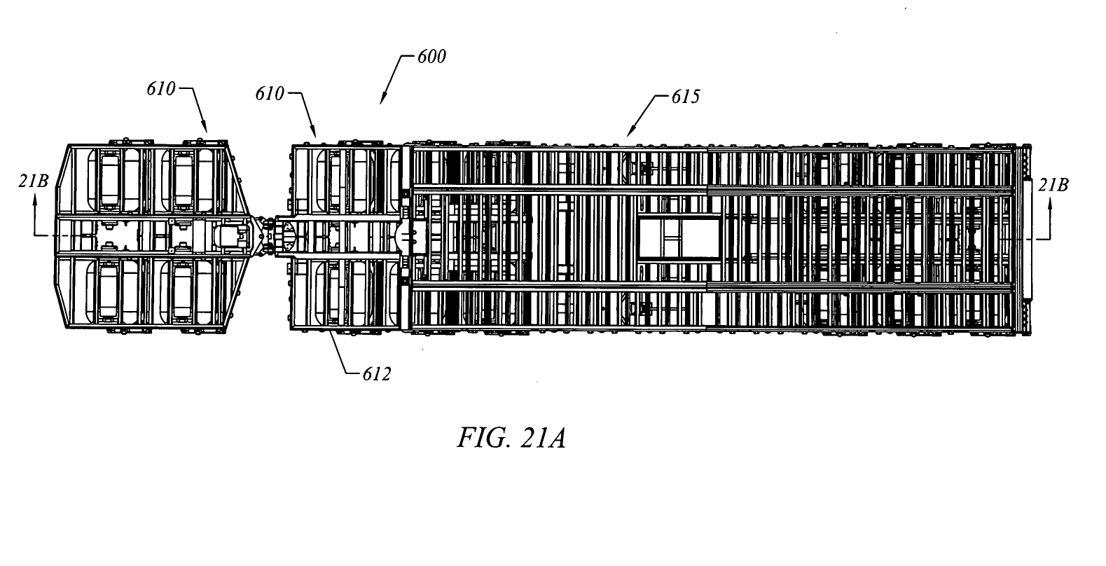

FIGS. 20A and 20B illustrate a further embodiment of a somewhat larger tractor including ten airbag tires, all of which are independently driven by separate motors as shown and described above. FIG. 20A illustrates vehicle 510 having a first frame section 511 and a second frame section 512 connected by articulation joint 587. The front frame section 511 is supported by four airbag tires, each of which is separately powered. The rear frame section 512 is supported by six airbag tires, each of which is separately and independently powered. In the interest of brevity, the separate motors and drive rollers will not be separately identified in some of the drawings.

FIG. 20B is a center sectional view on the line 20B-20B of FIG. 20A and illustrates front and rear frame sections 511 and 512 with four powered airbag tires in the case of frame section 511 and six independently powered airbag tires in the case of rear frame section 512.

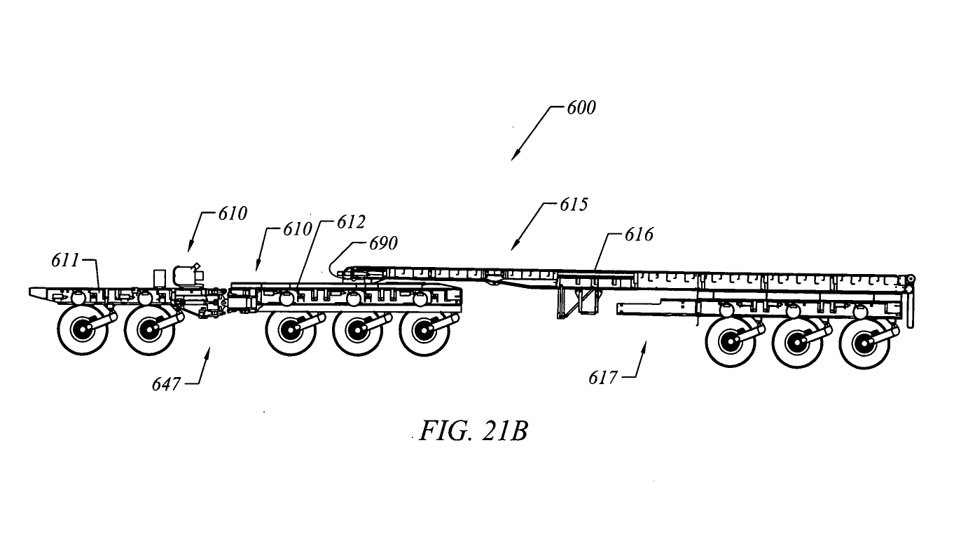

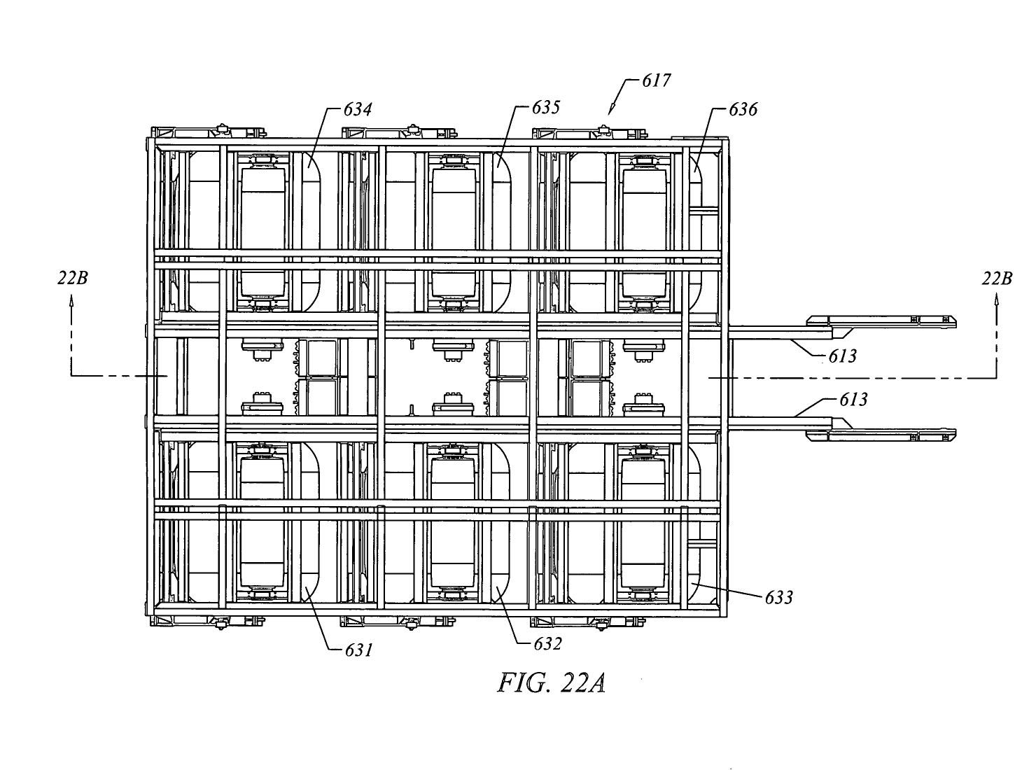

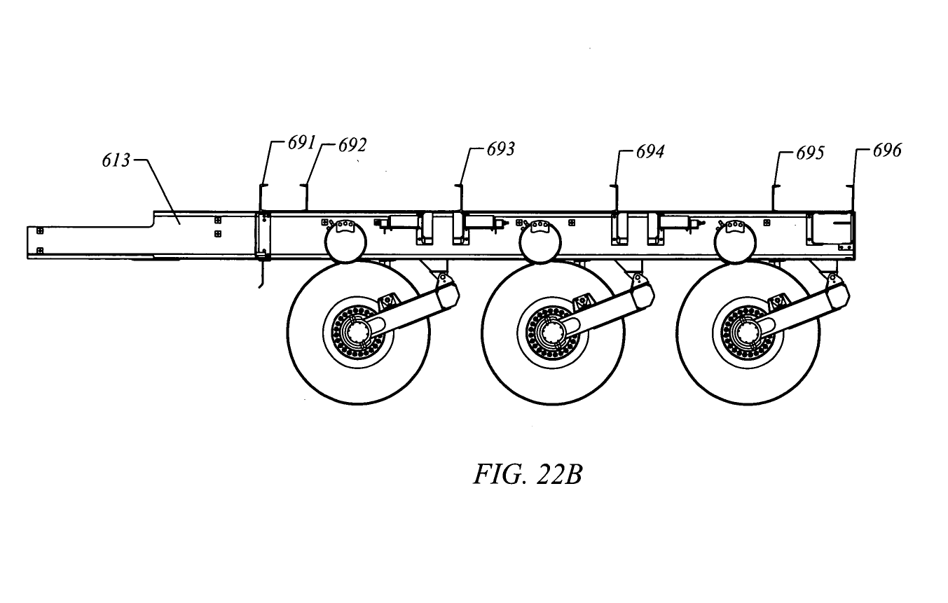

FIGS. 21A and 21B illustrate a heavy duty tractor trailer vehicle shown generally as 600 which includes a tractor shown as 610 and a trailer shown as 615. Trailer 615 includes trailer bogie 617 and flatbed load carrying surface 616. The tractor trailer combination 600 is capable of carrying large loads on the upper surface 616 of trailer 615. The tractor 610 includes ten airbag tires separately driven, four of which support frame section 611 and six of which support frame section 612. Frame sections 611 and 612 are connected by articulation joint 647. Trailer 615 is supported by six airbag tires (in addition to the rear six airbag tires of tractor 610), all of which are driven independently by separate electric motors. Trailer 615 is connected to tractor 610 by mounting joint 690 known in the art. The rearmost portion of trailer 615 is supported by a trailer bogie 617. Trailer bogie 617 is illustrated in further detail in FIGS. 22A and 22B. Bogie 617 has frame section 613 supported by six independently driven airbag tires 631-636, as shown in FIG. 22A. FIG. 22B is a section on the line 22B-22B of FIG. 22A. Frame section 613 carries a plurality of generally U-shaped support members 691-696 (FIG. 22B) which are carried by the upper surface of frame member 613. Supports 691-696 bear the weight of the trailer flatbed 616 shown in FIG. 21B.

It is understood that the invention includes vehicles having various numbers of airbag tires, various numbers of frame sections and various combinations of driven airbag tires and non-driven airbag tires.

The embodiments shown in FIGS. 17A-22B all include independent motor controllers such as controllers 151-154 as shown in FIGS. 6-10 and described above. The motor controllers are preferably, but not necessarily, capable of sensing and controlling instantaneous speed and torque of the respective motor it controls.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. A drive system for an off-road vehicle that moves across unprepared terrain, such as snow, tundra or ice, for example, wherein a plurality of n flexible airbag tires are in contact with the terrain, and a plurality of n top drive rollers carried by the chassis of said vehicle contact and frictionally engage and drive said airbag tires, said drive system comprising:
a plurality of n electromotive drive motors connected to each of said n top drive rollers,
speed sensing means for sensing the instantaneous rotational speed of each of said drive motors,
torque sensing means for sensing the instantaneous torque being produced by each of said drive motors, and
control means responsive to said speed sensing means and said torque sensing means for controlling the instantaneous speed and torque of each of said n drive motors.

2. The apparatus of claim 1 further comprising steering means interacting with said control means whereby actuation of said steering means causes said control means to change the speed of a least one of said drive motors to assist the steering of said vehicle.

3. The apparatus of claim 1 further comprising braking means interacting with said control means whereby actuation of said braking means causes said control means to either slow or reverse the rotational speed of at least two of said n top drive rollers.

4. The apparatus of claim 3 further comprising regenerative electrical power generation means coupled with and responsive to said braking means and to at least two of said drive rollers to convert rotational kinetic energy of said at least two of said drive rollers to electrical energy.

5. The apparatus of claim 1 wherein n=4.

6. The apparatus of claim 1 further comprising means for cutting off power to one of said drive motors wherein the top drive roller driven by said one of said drive motors loses contact with its respective airbag tire.

7. The apparatus of claim 1 further comprising one or more non-driven airbag tires.

8. The apparatus of claim 1 further comprising a tractor having eight driven airbag tires.

9. The apparatus of claim 8 further comprising an articulating joint in said chassis.

10. The apparatus of claim 9 further comprising a trailer having a plurality of driven airbag tires.

11. A drive system for an off-road vehicle that moves across unprepared terrain, such as snow, tundra or ice, for example, wherein a plurality of n flexible airbag tires are in contact with the terrain, and a plurality of n top drive rollers carried by the chassis of said vehicle contact and frictionally engage and drive said airbag tires, said drive system comprising:
a plurality of n electromotive drive motors connected to each of said n top drive rollers, and
control means for independently controlling the instantaneous speed and torque of each of said n drive motors.

12. The apparatus of claim 11 further comprising steering means interacting with said control means whereby actuation of said steering means causes said control means to change the speed of a least one of said drive motors to assist the steering of said vehicle.

13. The apparatus of claim 11 further comprising braking means interacting with said control means whereby actuation of said braking means causes said control means to either slow or reverse the rotational speed of at least two of said n top drive rollers.

14. The apparatus of claim 13 further comprising regenerative electrical power generation means coupled with and responsive to said braking means and to at least two of said drive rollers to convert rotational kinetic energy of said at least two of said drive rollers to electrical energy.

15. The apparatus of claim 11 wherein n=4.

16. The apparatus of claim 11 further comprising means for cutting off power to one of said drive motors wherein the top drive roller driven by said one of said drive motors loses contact with its respective airbag tire.

17. The apparatus of claim 11 further comprising one or more non-driven airbag tires.

18. The apparatus of claim 11 further comprising a tractor having eight driven airbag tires.

19. The apparatus of claim 18 further comprising an articulating joint in said chassis.

20. The apparatus of claim 19 further comprising a trailer having a plurality of driven airbag tires.
